(19) United States
(12) Patent Application Publication
(10) Pub. No.: US 2023/0405780 A1
(43) Pub. Date: Dec. 21, 2023

(54) TORSION SPRING TENSIONING TOOL

(71) Applicant: Assa Abloy Entrance Systems AB, Landskrano (SE)

(72) Inventors: Antonius PETERSE, Soest (NL); Paul WENSING, Woudenberg (NL); Lambertus VAN DEN HAZEL, Putten (NL)

(21) Appl. No.: 18/038,267

(22) PCT Filed: Nov. 30, 2021
(86) PCT No.: PCT/EP2021/083604

§ 371 Date: May 23, 2023

(30) Foreign Application Priority Data
Dec. 1, 2020 (SE) 2030352-5

(51) Int. Cl. B25B 27/30

(52) U.S. Cl. CPC B25B 27/306

(57) ABSTRACT

Torsion spring tensioning tool for tensioning a torsion spring of a counterbalancing mechanism of an overhead door, wherein the torsion spring tensioning tool comprises a housing, a gear wheel arrangement adapted to be mounted on a shaft of a the counterbalancing mechanism, said gear wheel arrangement comprising a gear wheel rotatably arranged in the housing, the torsion spring tensioning tool further comprising a gear mechanism coupled to the gear wheel for rotating said gear wheel. The gear wheel arrangement comprises a fixating arrangement fix to the gear wheel and adapted engage the shaft of the counterbalancing mechanism and transmit a rotational movement from the gear wheel to the torsion spring.

### TECHNICAL FIELD

Present invention relates to a torsion spring tensioning tool for tensioning a torsion spring of a counterbalancing mechanism of an overhead door.

### BACKGROUND

In overhead doors, a counterbalancing mechanism is usually used to counterbalance the weight of the door in order to reduce the force required for operating the door. This reduces the human effort or the motor power required to open the door. The counterbalancing mechanism usually comprises one or two torsion springs arranged around a shaft. One end of the torsion spring is fixed e.g. by a stationary cone. The other end of the torsion spring usually comprises a winding cone that is securable to the shaft by tightening screws and sometimes by a key. The winding cone is commonly provided with four radial holes for winding of the spring either by hand operated rods or by a tensioning tool for tensioning of the spring by rotation of the torsion spring before securing the winding cone to the shaft.

One type of tensioning tool is described in U.S. Pat. No. 8,616,093, where a torsion spring winding assembly comprises a coupling shaft structure for installation on a torsion spring winding cone, a gearbox assembly installed onto the coupling shaft structure and a sliding lever arm attached to the gearbox assembly and positioned against the inside of a garage door frame structure. The coupling shaft structure is comprised of two body halves fitted together by guiding pins and mating holes. Each body half has a winding hub portion. Each winding hub portion has two locking bolts hand tightened into winding bar slots on the winding cone. The gearbox assembly has a gearbox end cap that is pivotable into an open position. The gearbox end cap fits around the coupling shaft structure. The gearbox assembly is securable to the coupling shaft structure. A screw gun applies a rotational force to the gearbox assembly. Known tensioning tools are complicated to mount on the shaft of the counterbalancing mechanism and require a large number of operations to connect the tensioning tool to the torsion spring.

There are tools available on the market, however such tools are only not very robust relative the high torque of the torsion spring. Tensioning tools according to prior art also comprises several parts that are complex, weak and sensitive to wear. Also, service personnel are often required to do maintenance on different brands and types of doors which requires a large number of tools for adjusting different shafts and winding plugs.

Thus, there exists a need for an improved tensioning tool.

### SUMMARY

According to an aspect, a torsion spring tensioning tool for tensioning a torsion spring of a counterbalancing mechanism of an overhead door is provided. The torsion spring tensioning tool comprises a housing, a gear wheel arrangement adapted to be mounted on a shaft of the counterbalancing mechanism.

The gear wheel arrangement comprises gear wheel rotatably arranged in the housing, the torsion spring tensioning tool further comprising a gear mechanism coupled to the gear wheel for rotating said gear wheel.

The gear wheel arrangement comprises a fixating arrangement fix to the gear wheel and adapted to engage the shaft of the counterbalancing mechanism and transmit a rotational movement from the gear wheel to the torsion spring. The fixating arrangement may be adapted to be fastened to the torsion spring of the counterbalancing mechanism and transmit a rotational movement from the gear wheel to the torsion spring. Fastened is herein to be interpreted broadly as in the fixating arrangement being in engagement with the shaft such that the movement of said fixating arrangement is prohibited in at least one rotational direction. The fixating arrangement may be considered an engaging arrangement.

The torsion spring tensioning tool further comprises a support gearing in engagement with the gear wheel such that the gear wheel is arranged between the support gearing and the gearing mechanism.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

Embodiments of the invention will be described in the following; reference being made appended drawings which illustrate non-limiting examples of how the inventive concept can be reduced into practice.

FIG. 1 depicts a torsion spring tensioning tool according to an embodiment in a first perspective view.

FIG. 2 depicts the tensioning tool according to the same embodiment in a second perspective view.

FIG. 3 depicts the tensioning tool according to the same embodiment in a third perspective view.

FIG. 4 depicts the tensioning tool according to the same embodiment in an exploded view.

FIG. 5 depicts a part of the housing and a lever of the tensioning tool according to same embodiment in a perspective view.

FIG. 6 depicts a gearing mechanism of the tensioning tool according to the same embodiment in a partially cross-sectional view.

FIG. 7 depicts a gear wheel of the tensioning tool according to an embodiment in a front view.

FIG. 8 depicts the gear wheel of the tensioning tool according to the same embodiment in a side view.

FIG. 9 depicts the gear wheel of the tensioning tool according to the same embodiment in a perspective view.

FIG. 10 depicts the gear wheel of the tensioning tool according to an embodiment.

### DETAILED DESCRIPTION

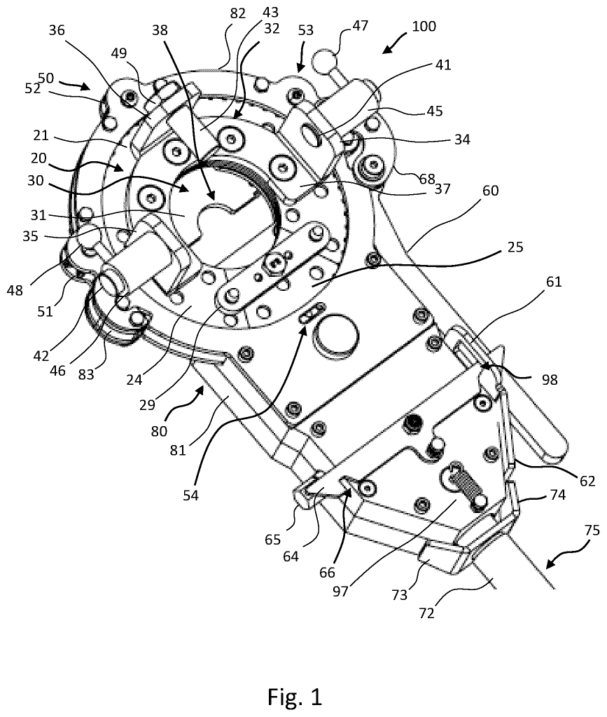

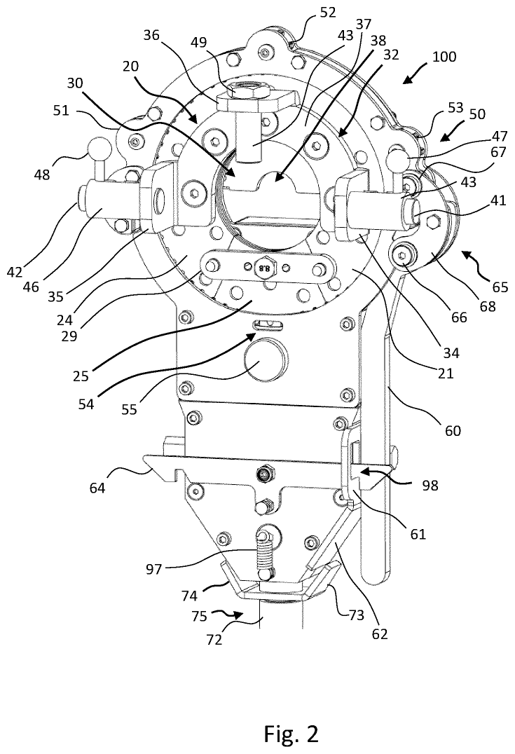

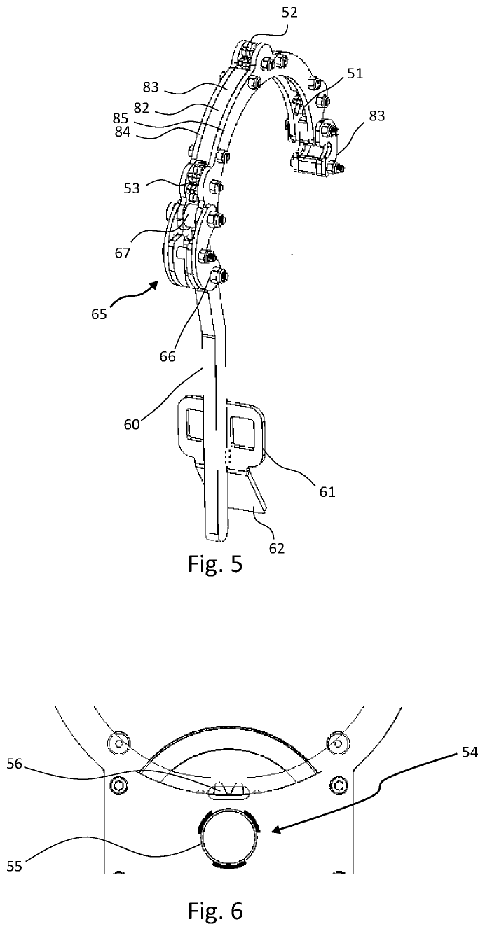

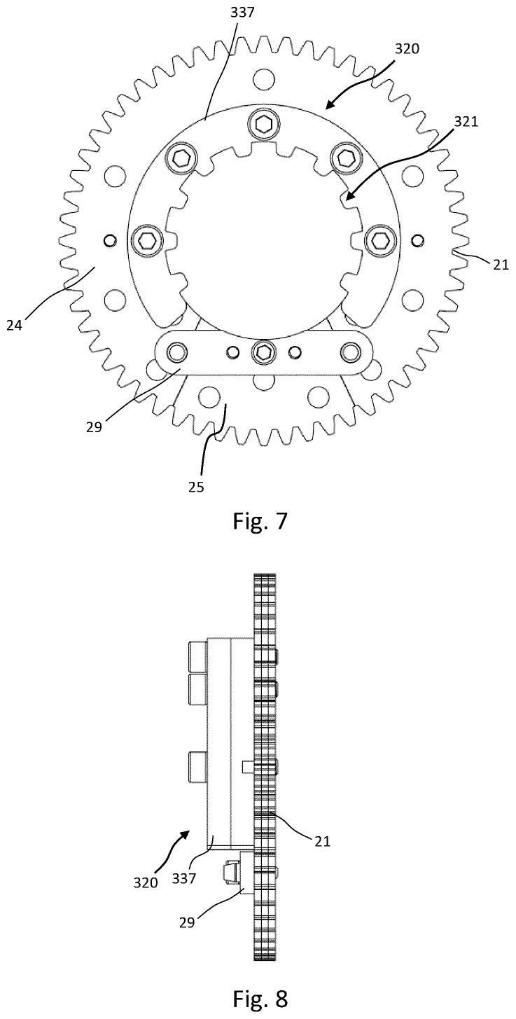

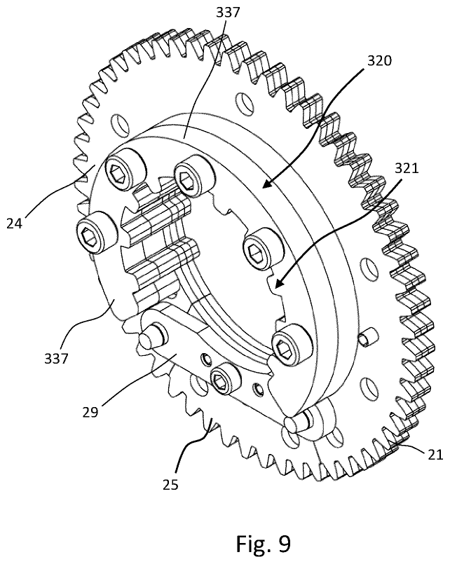

A spring tensioning tool 100 for tensioning a torsion spring of a counterbalancing mechanism of an overhead door is depicted in FIGS. 1-4. Details of the spring tensioning tool are depicted in FIGS. 5-6. Alternative embodiments of the gear wheel and fixating arrangement of the tensioning tool are depicted in FIGS. 7-10.

The torsion spring tensioning tool 100 comprises a housing 80 and a gear wheel arrangement 20. The gear wheel arrangement 20 is adapted to be mounted on a shaft of the counterbalancing mechanism.

The gear wheel arrangement 20 comprises a gear wheel 21. The gear wheel 21 is rotatably arranged in the housing 80.

The torsion spring tensioning tool 100 further comprises a gear mechanism 54. The gear mechanism 54 is coupled to the gear wheel 21 for rotating said gear wheel 21.

The gear wheel arrangement 20 further comprises a fixating arrangement 32. The fixating arrangement 32 is fix to the gear wheel 21. Further, the fixating arrangement is adapted to engage the shaft of the counterbalancing mechanism and transmit a rotational movement from the gear wheel 21 to the torsion spring. The fixating arrangement 32 may be adapted to be fastened to the torsion spring of the counterbalancing mechanism and transmit a rotational movement from the gear wheel 21 to the torsion spring. The fixating arrangement 32 is thus adapted to transmit a rotational movement from the gear wheel 21 to the torsion spring for tensioning the torsion spring. The rotational movement accordingly provides a tensioning torque for the torsion spring.

The gear mechanism allows for tensioning of the torsion spring with the tool in a simple manner by rotation of the gear mechanism. Thus, a more safe and user friendly tensioning may be achieved.

The torsion spring tensioning tool may comprise a support gearing 50. The support gearing 50 is in engagement with the gear wheel 21 is arranged between the support gearing 50 and the gearing mechanism 54. The support gearing provides additional support for the gear wheel even when the gear wheel is subjected to a large torque. This is particularly advantageous due to the large torques present in the counterbalancing mechanism.

The gear wheel 21 comprises teeth along the circumference of said gear wheel 21. Said teeth extends radially outwards from a center of the gear wheel 21. In one embodiment, the gear wheel 21 may comprise a gear rim. The gear rim is arranged along the circumference of the gear wheel. The gear rim may comprise the teeth. The term gear rim herein refers to a toothed surface. The toothed surface consequently forms the engagement interface of a gear.

The gear wheel 21 may comprise a first wheel segment 21 and a second wheel segment 25. The second wheel segment 25 is axially attachable to and axially detachable from the first wheel segment 24. The first wheel segment 24 is adapted to be mounted on the shaft of the counterbalancing mechanism when the second wheel segment 25 is in a detached state.

The second wheel segment 25 is accordingly detachable from the first wheel segment 24 by an axial movement of the second wheel segment 25 in relation to the first wheel segment 24. Axial movement herein refers to movement in an axial direction relative the gear wheel 21.

Thus, the gear wheel 21 may be divided into the first wheel segment 24 and the second wheel segment 25. The split gear wheel allows for an easier and more user friendly mounting of the tool to the torsion spring.

As an alternative, the gear wheel may comprise further wheel segments and then all the wheel segments together form a complete gear wheel. Each wheel segment 24, 25 can be seen as a piece of a pie. The first wheel segment 24 is preferably larger than the second wheel segment 25 and then the first wheel segment 24 may be seen as a major wheel segment 24 and the second wheel segment 25 may be seen as a minor wheel segment 25.

By a wheel segment as used herein is meant an element being a part of a circle. A wheel segment is preferably substantially formed as a piece of a pie. A wheel segment may substantially have the shape of a circular sector.

The first and second wheel segments 24, 25 are releasable form each other. The second wheel segment 25 is detachable from the first wheel segment 24. The second wheel segment 25 is in an attached state when the second wheel segment 25 is attached to the first wheel segment 24, i.e. when the first wheel segment 24 and the second wheel segment 25 are attached to each other. The second wheel segment 25 is in a detached state when the second wheel segment 25 is detached from the first wheel segment 24, i.e. when the first wheel segment 24 and the second wheel segment 25 are separated from each other. The first wheel segment 24 comprises a first set of teeth and the second wheel segment 25 comprises a second set of teeth. The first set of teeth is arranged along a first arc of the first wheel segment 24 and the second set of teeth is arranged along a second arc of the second wheel segment 25. The teeth of the first and second set of teeth are directed radially outwards. The first set of teeth and the second set of teeth may together form the gear rim when the second segment 25 is in the attached state.

In the attached state, the second wheel segment 25 interacts with the first wheel segment 24 such that the second wheel segment 25 is obstructed from moving radially inwards. The second wheel segment 25 is thereby fixed radially inwards in relation to the first wheel segment 24.

When the first wheel segment 24 is mounted on the shaft of the counterbalancing mechanism and the fixating arrangement 32 is connected to the torsion spring, the second wheel segment 25 is axially detachable from the first wheel segment 24, i.e. the second wheel segment 25 is axially detachable from the attached state to the detached state. Thus, the second wheel segment 25 is adapted to be axially inserted into a through slot and axially removed from the through slot. The second wheel segment 25 is detachable in a single direction, i.e. axially. The second wheel segment 25 is only axially detachable from the first wheel segment 24.

The first and second wheel segment may be interconnected by means of a connecting plate 29. The connecting plate 29 has a first portion axially connected to the first wheel segment 24 and a second portion axially connected to the second wheel segment 25.

The gear wheel 21 may be formed as a ring wheel, i.e. a ring gear wheel, arranged in the housing 80. Thus, the first and second wheel segment may be considered annular segments. The ring wheel shape allows for accommodation of shafts of different dimensions.

The gear wheel arrangement 20 comprises the fixating arrangement 32 adapted to be connected to the torsion spring of the counterbalancing mechanism. This may be performed by connecting the fixating arrangement 32 to the shaft of the counterbalancing mechanism which in turn is connected to said spring. The fixating arrangement 32 is adapted to be connected to, i.e. fastened to, a winding cone, which is connected to the torsion spring. The winding cone may be formed as a part of the shaft of the counterbalancing mechanism.

The fixating arrangement 32 comprises a plurality of engagement members 41, 42, 43. Each engagement member 41, 42, 43 is adapted to engage corresponding engaging members of the shaft of the counterbalancing mechanism.

The engagement members 41, 42, 43 may be radially connectable to the torsion spring. The engagement members are radially connectable to a winding cone, which is connected to the torsion spring and forms a part of the shaft of the counterbalancing mechanism. The winding cone comprises the corresponding engaging members of the shaft of the counterbalancing mechanism.

The corresponding engaging members may be holes. Preferably, the corresponding engaging members may be radial holes.

Accordingly, the engagement members 41, 42, 43 may be radially insertable into the corresponding engaging members (radial holes) in the winding cone. A winding cone usually comprises several radial holes, commonly four radial holes. The engagement members 41, 42, 43 may be radially insertable in at least a plurality of the radial holes of the winding cone. In operation, the engagement members 41, 42, 43 transmits a rotational movement from the gear wheel 21 to the torsion spring.

In one embodiment, the fixating arrangement 32 may comprise at least three engagement members 41, 42, 43. The engagement members 41, 42, 43 may be substantially evenly distributed along a first half of the gear wheel 21.

Preferably, the plurality of engagement members 41, 42, 43 are in the form of pins. The plurality of engagement members 41, 42, 43 may comprise a threaded adjustable pin 43 and at least one retractable pin 41, 42.

The threaded adjustable pin 43 may be arranged 90 degrees from each of a first and second retractable pin 41, 42. The first retractable pin 41 may be opposite to the second retractable pin 42 relative the gear wheel 21.

The retractable pins 41, 42 may each movably mounted in a sleeve. Said sleeve being arranged with an elongated recess extending in a radial direction relative the gear wheel. To allow for adjustment, the retractable pin 41, 42 may be provided with an adjustment element 47, 48 protruding through the elongated recess. Movement of the adjustment element 47, 48 along the elongated recess thus causes radial movement of the retractable pin 47, 48, i.e. relative movement relative the gear wheel 21.

The fixating arrangement 32 comprises a plurality of distance members 34, 35, 36 adapted to arrange the gear wheel 21 remote from the torsion spring. The distance member 34, 35, 36 are also adapted to arrange the gear wheel 21 remote from the winding cone of the torsion spring. Thereby, the gear wheel 21 is arranged remote from the torsion spring such that there is a distance between the gear wheel 21 and the torsion spring as well as the winding cone. The distance between the gear wheel 21 and the torsion spring as well as the winding cone enables mounting of a key on the shaft, which key rotationally locks the winding cone on the shaft.

The key is insertable into a key groove formed in the shaft of the counterbalancing mechanism and a key groove formed in the winding cone. The engagement members 41, 42, 43 are each connected to a respective distance member 34, 35, 36 such that the engagement members 41, 42, 43 are arranged remote from the gear wheel 21. The distance members 34, 35, 36 extends axially from the gear wheel 21. The engagement members 41, 42, 43 each extends radially the respective distance member 34, 35, 36.

In one embodiment, the engagement members 41, 42, 43 may each extend radially from a distal end of their respective distance member, which distal end is opposite to a proximal end attached to the gear wheel. The distance members 34, 35, 36 may be elongated distance members 34, 35, 36. Each distance member 34, 35, 36 and corresponding engagement member 41, 42, 43 may together have an L-shape.

The fixating arrangement 32 may comprise a fixating plate 37. Said fixating plate 37 is attached to the gear wheel 21. The distance members 34, 35, 36 may be formed as protrusions extending axially from said fixating plate 37. A first main surface of the fixating plate 37 may be in contact with the gear wheel 21. The distance members 34, 35, 36 may protrude axially from a second main surface of the fixating plate, said second main surface being opposite to the first main surface.

As aforementioned, the torsion spring tensioning tool 100 comprises a housing 80. The gear wheel 21 is rotatably arranged in the housing 80. The housing 80 encloses the circumferential periphery of the gear wheel 21.

The housing 80 may be adapted to axially lock the second wheel segment 25 in relation to the first wheel segment 24. The housing 80 may be adapted to lock the second wheel segment 25 in relation to the first wheel segment 24 during rotation of the gear wheel 21. The housing 80 comprises a flange 83 arranged along the circumference of the gear wheel 21. The flange 83 comprises a first lip 84 arranged on one axial side of the gear wheel 21 and a second lip 85 arranged on the other axial side of the gear wheel 21. The gear wheel 21 is thus rotatably arranged in the flange 83, i.e. between the first lip 84 and the second lip 85.

The flange 83 may axially lock the first wheel segment 24 and the second wheel segment 25.

The housing 80 comprises a first housing part 81 and a second housing part 82. The first housing part 81 and the second housing part 82 are movable in relation to each other such that the gear wheel 21 (i.e. gear wheel arrangement 20) is detachable from the housing 80. Thus, the user may be able to set up and adapt the tool in a user-friendly and non-complex manner.

The second housing part 82 may comprise the flange 83. Thus, the second housing part 82 partially envelops the circumference of the gear wheel 21 by means of said flange 83.

Thus, the first housing part 81 and the second housing part 82 may be movable in relation to each other to enable opening of the housing 80. Thereby, access to the interior of the housing 80 is achieved. In one embodiment, the second housing part 82 may be detachable from the first housing part 81. In one embodiment, the second housing part 22 may be shaped as a circle arc.

The first housing part 81 and the second housing part 82 may be interconnected by means of a pivot connection 65. The pivot connection 65 comprises a hinge element 68.

Further, the first housing part 81 may be lockable to the second housing part 82 by means of a locking arrangement.

The locking arrangement comprises a locking element 83. The locking element 83 is movable between an engaged position and a disengaged position. In the engaged position, the locking element 83 locks the first housing part 81 relative the second housing part 82. In the disengaged position, the locking element 83 releases first housing part 81 relative the second housing part 82.

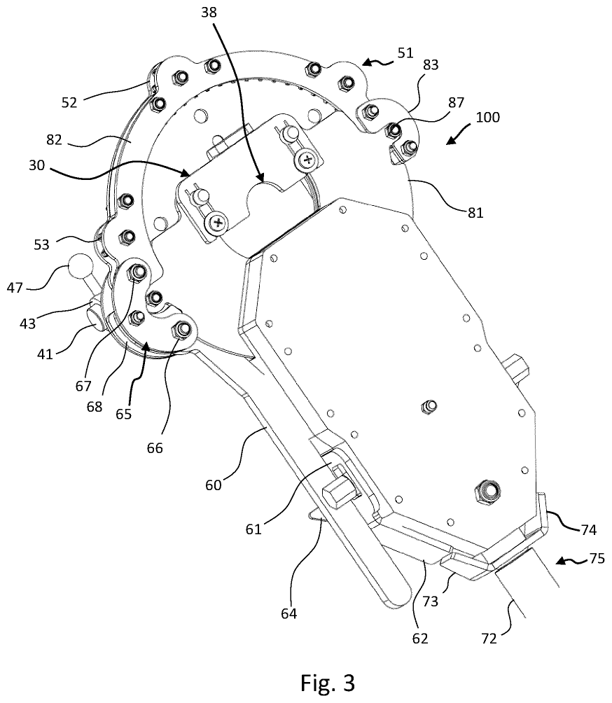

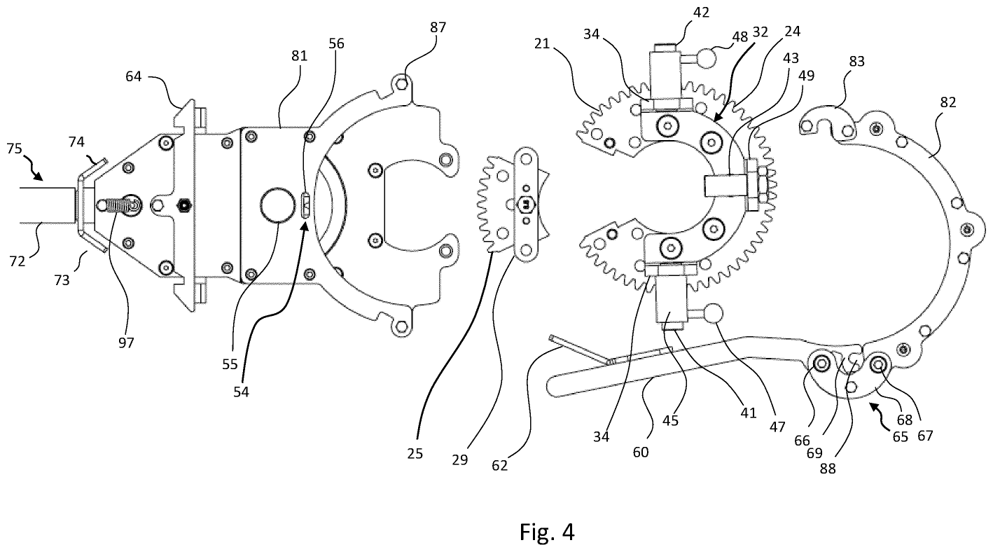

The locking element 83 may be pivotally connected to one of the first housing part 81 and the second housing part 82. The other of the first housing part 81 and the second housing part 82 may provided with a retention part 87 (as most clearly depicted in FIGS. 3 and 4). In the engaged position the locking element 83 is in engagement with the retention part 87. The locking element 83 may be moved to said engaged position by means of pivoting. In the engaged position the locking element 83 may latch onto the retention part 87, thereby locking the first housing part 81 relative the second housing part 87. The locking element 87 may have a C-shape, whereby the retention part 87 may be formed as a protrusion extending radially outwards on the first or second housing part.

The torsion spring tensioning tool 100 may further comprise a lock lever 60. The lock lever 60 is pivotally connected to the pivot connection 65. The lock lever 60 is pivotable between a first lock lever position and a second lock lever position. The lock lever 60 is arranged to fixate the pivot connection 65 relative the second housing part 82 in the first lock lever position and accommodate relative between the second housing part 82 and the pivot connection 67 in the second lock lever position.

Thus, the relative pivoting between the first and second housing part may be mitigated during use of the tensioning tool. This allows for a much more robust and secure tensioning of torsion spring.

As aforementioned, the pivot connection may comprise a hinge element 68. The hinge element 68 is pivotally connected the second housing part 82 by means of a first pivot point 67. The hinge element is pivotally connected to the lock lever 60 by means of a second pivot point 66. The hinge element 68 may be substantially C-shaped. A first end portion of the hinge element 68 may be provided with the first pivot point 67 and a second opposite end portion of the hinge element 68 may be provided with the second pivot point 66.

As most clearly depicted in FIG. 4, one of the second housing part 82 and the lock lever 60 may comprise a tongue 88. The other of the second housing part 82 and the lock lever 60 comprises a groove 69. The tongue 88 and the groove 69 are arranged to engage and secure the second housing part 82 to the lock lever 60 when the lock lever 60 is in the first lock lever position. Thereby, the pivot connection 65 becomes substantially locked in place by means of the fix connection between the housing and the lever arm.

Advantageously, the tongue 88 or groove 69 is arranged at a first end of the lock lever 60. Accordingly, an intermediate portion of the lock lever 60 may be pivotally connected to the pivot connection 65, i.e. the hinge element 68. A second end of the lock lever 60 is actuatable relative the housing 80.

Preferably, the second housing part 82 comprises the tongue 88 and the lock lever 60 comprises the groove 69.

Further, pivoting of the lock lever 60 in a first direction causes tensioning in the locking element 83 and pivoting in a second direction causes relaxation in the locking element 83 when the locking element 83 is in the engaged position. The second direction is opposite to the first direction.

The lock lever 60 may comprise a projection 62 arranged to come into contact with the housing 80 to provide a stop for the movement of the lock lever 60 upon reaching the first lock lever position.

The projection 62 may be arranged at the second end of the lock lever 60. The projection may extend in an inclined angle relative the lock lever 60. The housing 80 have a correspondingly angled section for coming into contact with said projection 62.

In order to secure the lock lever in position and decrease the risk for the housing parts accidentally coming out of engagement during use, the tool may comprise a securing member. The securing member 64 is adapted to engage the lock lever 60 in the first lock lever position to secure the lock lever 60. In one embodiment, the lock lever 60 is arranged parallel to the housing 80 in the first lock lever position.

The securing member 64 may be pivotable relative the housing 80. The lock lever 60 may comprise a securing portion 61. The securing member 64 may be pivotable between an engaged position and a disengaged position. In the engaged position the securing member 64 engages the securing portion for securing the position of the lock lever 60, i.e. the position of the lock lever 60 relative the housing 80. In the disengaged position the lock lever 60 is freely pivotable between the first lock lever position and the second lock lever position.

The securing member may be connected to the housing 80 by means of a spring 97. The spring 97 resiliently biases the securing member 64 towards the engaged position.

The securing member 64 may be provided with a retention latch 98 for engaging the securing portion 61. The securing portion 61 may be in the form of a recess in the lever arranged to receive said retention latch 98 when the lock lever 60 is in the first lock lever position. The recess may be comprised in a plate member of the lock lever 60. The recess may extend through a plane parallel to the extension of the lock lever 60. To secure the lock lever 60 the securing member 64 is thus pivoted into engagement with recess, whereby the retention latch 98 latches onto the rim of said recess.

The tensioning tool may further comprise a handle lever. The handle lever facilitates mounting of tensioning tool on the shaft of the counterbalancing mechanism and operation of the tensioning tool since the housing can easily be moved by hand during mounting and easily be kept by hand during operation.

The handle lever 75 is pivotally coupled to the housing 80 such that the handle lever 75 is pivotable relative the housing 80 between a first and second pivot end position. In the first and second pivot end position the handle lever 75 engages the housing 80.

The handle lever 75 may comprise abutment elements 73, 74 arranged to engage the housing 80 in the first and second pivot end position. Thus, a stop for accidental movement of the handle lever as well as the entire tensioning tool due to large torques during tensioning is provided.

In one embodiment, one of the abutment elements 73, 74 is arranged to press the projection 62 of the lock lever 60 against the housing 80 when the handle lever 75 is in the first pivot end position.

The handle lever 76 comprises an elongated handle 72. The abutment elements 73, 74 may each extend in a sharp angle relative the elongated handle 72 towards the housing 80. Thus, a first abutment element 73 extends in a first sharp angle relative the elongated handle towards the housing 80. Correspondingly, the second abutment element 74 may extend in a second sharp angle relative the elongated handle 72 towards the housing 80. The second sharp angle may be opposite to the first.

As most clearly depicted in FIG. 6, the gear mechanism 54 may rotate the gear wheel 21 during operation of the tensioning tool 100. Since the fixating arrangement 32 is fix to the gear wheel 21, which in operation is connected to the torsion spring of the counterbalancing mechanism and transmits a rotational movement from the gear wheel 21 to the torsion spring, the torsion spring is wound when the gear wheel 21 is rotated. Depending on the direction of the rotation of the gear wheel 21, the torsion spring is either wound up and thereby tensioned or unwound and thereby relaxed, the latter implying that the tension of the torsion spring is reduced.

The gear mechanism provides rotational support to the gear wheel, whereby a more robust tensioning tool is achieved. Further, a more safe tensioning is achieved due to the tool being less susceptible to the large torque exerted to the tool by the torsion spring.

The gear mechanism 54 may be adapted to be rotated by an external drive unit. An external drive unit may be connectable to a rotation member 55 of the gear mechanism 54. Thereby, the rotation member 55 is driven by the external drive unit. The rotation member 55 is rotated by the external drive unit.

The gear mechanism may comprise a transmission element. The transmission element 56 may be a gear wheel. The transmission element is rotatably arranged in the housing. The transmission element may be rotatably arranged in the first housing part 81.

The transmission element 56 is connected to the rotation member 55 and arranged to transfer torque from the rotation member 55 to the gear wheel 21.

In one embodiment, the transmission element 56 be in engagement with the gear wheel 21 and may be fix relative the rotation member 55. The rotation member 55 may be coaxial to the transmission element 56.

Thus, the rotation member 55 rotates the transmission element 56. The transmission element 56 rotates the gear wheel 21. The gear wheel arrangement 20 with the gear wheel 21 is connected to the torsion spring by means of the fixating arrangement 32. Thereby, the torsion spring is tensioned by the external drive unit. The external drive unit may be a screw gun or a drilling machine. The gear mechanism 54 and in particular the rotation member 55 is adapted to be connected to a screw gun or drilling machine.

The support gearing 50 will now be described in further detail with reference to the Figures. The support gearing 50 is in engagement with the gear wheel 21 for providing rotational support for said gear wheel 21. In other words, the support gearing 50 is rotatably coupled to the housing 80 and the gear wheel 21 to function as a reduction gearing. Accordingly, the support gearing may be considered a reduction gearing.

The support gearing 50 may be rotatably arranged in the housing 80. The support gearing may be rotatably arranged in the second housing part 82.

The support gearing 50 may comprise a plurality of cogged wheels 51, 52, 53. Each of the cogged wheels 51, 52, 53 may engage the gear wheel 21.

The plurality of cogged wheels 51, 52, 53 are distributed along the circumference of gear wheel 21. As depicted in FIGS. 1-4, the plurality of cogged wheels may comprise a first cogged wheel 51, a second cogged wheel 52 and a third cogged wheel 53. The first, second and third cogged wheel may be substantially evenly distributed along a first half of the circumference of the gear wheel 51. The gearing mechanism 54 may be in engagement with the gear wheel 21 at a position on a second half of gear wheel.

The first, second and third gear wheel 51, 52, 53 and the gearing mechanism 54, i.e. the transmission element 56, may be evenly distributed along the circumference of the gear wheel 21.

Each of the cogged wheels 51, 52, 53 are rotatably arranged in the housing 80. Each of the cogged wheels 51, 52, 53 are connected to the housing by means of shafts arranged in the housing 80, i.e. the second housing part 82.

The support gearing may be rotatably arranged inside the flange 83 of the second housing part 82. Thus, the cogged wheels 51, 52, 53 are rotatably connected to the first lip 84 and/or the second lip 85.

The torsion spring tensioning tool 100 may comprise an adapter plate 30. The adapter plate is releasably mounted to the housing 80. The adapter plate 30 is adapted to be mounted on the shaft of the counterbalancing mechanism. This allows for a tool which is adaptable for different overhead doors with various counterbalancing mechanism by exchanging of the adapter plate to a different adapter plate suitable for the dimensions of the counterbalancing mechanism in question.

Accordingly, the adapter plate 30 may comprise an aperture 38 for accommodating the shaft of the counterbalancing mechanism.

The adapter plate 30 may be mounted to the first housing part 81 of the housing 80. The adapter plate 30 may be mounted to the housing 80 by means of fasteners such as screws.

A counterbalancing mechanism is usually used in overhead sectional doors. Thus, the overhead door may be an overhead sectional door.

The mounting, operation and removal of the torsion spring tensioning tool 100 according to one embodiment is hereinafter described.

The tensioning tool 100 may be mounted on a shaft of a counterbalancing mechanism and connected to a torsion spring in the following way. The second housing part 82 is released relative the first housing part by means of the locking arrangement. The gear wheel 21 is detached and removed from the housing 80. Further, the gear wheel 21 is detached from engagement with the gearing mechanism 54 and the support gearing 50. The second wheel segment 25 is axially detached and separated from the first wheel segment 21. A suitable adapter plate 30 is attached to the first housing part 81 and mounted on the shaft of the counterbalancing mechanism.

The first wheel segment 25 is mounted on the shaft of the counterbalancing mechanism by a radial motion such that the shaft is guided through the gear wheel 21 and the fixating arrangement 32 on the first wheel segment 24 is engaged, e.g. fixated, to the winding cone of the counterbalancing mechanism. The second wheel segment 25 is axially attached to the first wheel segment 25.

The gear wheel 21 is inserted into the housing and secured between support gearing 50 and the gearing mechanism 54 by means of the locking arrangement. The lock lever 60 is pivoted to the first lock lever position for securing the lock lever 60 and is secured by means of the securing member 64.

If the space is limited, e.g. if the counterbalancing mechanism is located close to a wall or ceiling, the first wheel segment 24 is preferably oriented such that the through slot for receiving the second wheel segment 25 is directed substantially towards the wall, the ceiling, or a corner formed where a wall meets a ceiling. Since the second wheel segment 25 is axially attached to the first wheel segment 24, no extra radial space is required to attach the second wheel segment 25 to the first wheel segment 24. The fixating arrangement 32 is not attached to the second wheel segment 25 and therefore only axial movement is necessary to install the second wheel segment 25. The first housing part 21 to which the handle lever 75 and in which the gear mechanism 54 is arranged, is preferably oriented such that the handle lever 75 is directed substantially away from the wall, the ceiling, or a corner formed where a wall meets a ceiling. The smaller second housing part 82 that is shaped as a circle arc is easily moved into a position close to the wall, the ceiling, or the corner and connected to the first housing part 81, even when the space is limited.

The tension tool 100 may be operated to tension the torsion spring of the counterbalancing mechanism in the following way. A screw gun is connected to the rotation member 55 such that rotation of the screw gun rotates the rotation member 55. The rotation member 55 may rotate the transmission element 56 at a lower rotational speed and the transferred torque is significantly higher than the torque of the screw gun. The transmission element 56 rotates the gear wheel 21. The transmission element 56 may rotate the gear wheel 21 at an even lower rotational speed and the transferred torque is even higher. The rotation of the gear wheel 21 is transferred to the winding cone via the fixating arrangement 32 fix to the gear wheel 21. Thereby, the torsion spring is wound. To tension the torsion spring, the direction of rotation of the screw gun is chosen such that the torsion spring is wound up.

When suitable tension of the torsion spring has been achieved, the winding cone is rotationally locked to the shaft of the counterbalancing mechanism by tightening tightening screws arranged in the winding cone and engaging the shaft and/or by inserting a key in a key groove formed in the shaft and the winding cone.

The tensioning tool 100 can be removed from the counterbalancing mechanism in the following way. The second housing part 82 is moved away from the first housing part 81 by means of releasing of the locking arrangement, i.e. the securing member and the lock lever. The gear wheel 21 is detached from the housing 80 and from engagement from the gearing mechanism 54 and support gearing 50. The second wheel segment 25 is axially detached from the first wheel segment 24 by axially moving the second wheel segment 25 out from the through slot of the gear wheel 21. The second wheel segment 25 is thereby axially detached and separated from the first wheel segment 24. The first wheel segment 24 is removed from the shaft of the counterbalancing mechanism by a radial motion such that the shaft is guided through the through slot for receiving the second wheel segment 25 and the fixating arrangement 32 on the first wheel segment 24 is disengaged from the winding cone of the counterbalancing mechanism. If the space is limited, e.g. if the counterbalancing mechanism is located close to a wall or ceiling, the rotation of the gear wheel 21 is preferably stopped such that the through slot for receiving the second wheel segment 25 is directed substantially towards the wall, the ceiling, or a corner formed where a wall meets a ceiling. Thereby, the first wheel segment 24 is easily removable from the shaft.

It is easily realized that the tensioning tool can be used to relax the tension of the torsion spring by operating the screw gun in the opposite direction.

FIGS. 7 to 9 depicts a gear wheel and a fixating arrangement according to an alternative embodiment.

Similar to the fixating arrangement depicted in FIGS. 1 to 4, the fixating arrangement 320 may comprise a plurality of engagement members 321. The engagement members 321 are adapted to engage corresponding engaging members of the shaft of the counterbalancing mechanism.

The fixating arrangement 320 functions similar to said fixating arrangement depicted in FIGS. 1 to 4, with the exception of the design of the engagement members.

Referencing said FIGS. 7 to 9, the plurality of engagement members 321 of the fixating arrangement 320 may form at least one cogged surface. The at least one cogged surface is adapted to engage corresponding engaging members in the form of splines of the shaft of the counterbalancing mechanism. The cogged surface may be adapted to engage with splines of the shaft of the counterbalancing mechanism. Thereby fastening of the fixating arrangement 320 to the torsion spring of the counterbalancing mechanism, e.g. a shaft of the counterbalancing mechanism, may be achieved. The cogged surface herein references a toothed surface with teeth intended to engage splines of the shaft.

The cogged surface may thus be adapted to fit a particular counterbalancing mechanism with a corresponding set of splines. This mitigates the need for an adapter plate since the alignment between the fixating arrangement and the shaft of the counterbalancing mechanism is easily achieved by the tight engagement between the splines and cogged surface. Thereby, the implementation of such a fixating arrangement allows for a tool which is easier to use. In addition, it achieves a tool which requires less space for the operation of tensioning of the torsion spring since the tool will be thinner without the adapter plate.

The at least one cogged surface may form at least a partial ring gear rim. The cogs may protrude radially from the rim. In the depicted and preferred embodiment, the at least one cogged surface forms a partial ring gear rim to allow a user to engage cogged surface and the splines of the shaft of the counterbalancing mechanism. A partial ring gear rim herein refers to gear rim formed as an arc section. Although not preferred, the cogged surface forms a full ring gear rim corresponding to the shaft of the counterbalancing mechanism.

As depicted both the gear wheel 21 and a separate plate fix to the gear wheel may be provided with the engagement members 321. Thus, the plurality of engagement members 321 may form a cogged surface of any one or each of the gear wheel 21 and a fixating plate 337 attached to the gear wheel 21. Each cogged surface may be adapted to engage with splines of the shaft of the counterbalancing mechanism. Thereby, fastening of the fixating arrangement 320 to the torsion spring of the counterbalancing mechanism, e.g. a shaft of the counterbalancing mechanism, may be achieved.

Thus, a first cogged surface of the fixating arrangement may be provided on the gear wheel 21 and a second cogged surface of the fixating arrangement may be provided on the fixating palate 337.

The gear wheel 21 may be formed as a ring wheel, i.e. a ring gear wheel, (as described with reference to FIGS. 1-4). The cogged surface may thus at least form a part of an internal ring gear rim of the ring gear. The cogs of the cogged surface formed on the gear wheel may be adapted to extend radially, i.e. radially towards the shaft when the tool is mounted to said shaft.

As aforementioned, the fixating plate 337 may be provided with engagement members 321. The cogged surface may accordingly form a gear rim of the fixating plate 337. Preferably the gear rim of the fixating plate 337 is inwardly facing, e.g. forms an internal gear rim. The cogs of the cogged surface provided on the fixating plate may be adapted to extend radially, i.e. radially towards the shaft when the tool is mounted to said shaft.

The cogged surfaces may be arranged in parallel and in alignment along an axial direction such that each cogged surface may engage the same corresponding splines.

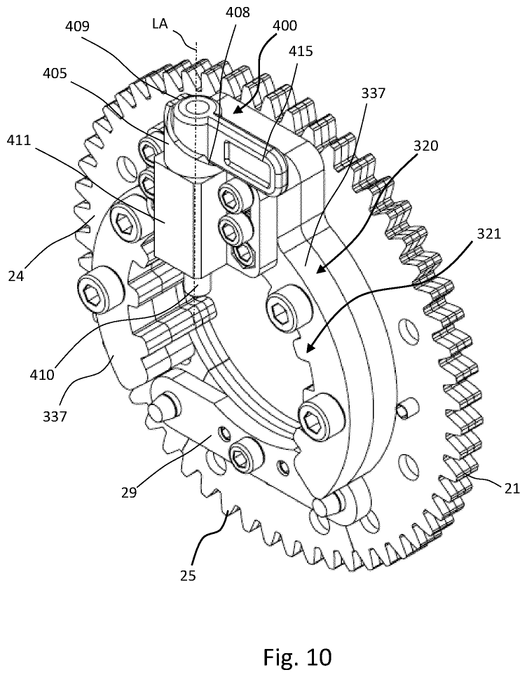

FIG. 10 depicts the gear wheel of FIGS. 7-9 further provided with an engagement member in the form of a latching pin 410 of a latch mechanism 400. The corresponding engaging member of the shaft of the counterbalancing mechanism may accordingly be in the form a corresponding groove, the latching pin 410 being adapted to engage said groove.

The fixating arrangement 320 may thus further comprise the latching mechanism 400. The latching mechanism 400 has a latching pin 410. The latching pin 410 is adapted to engage the corresponding groove of the shaft of the counterbalancing mechanism. The latching mechanism allows for locking the tool in place relative the axial direction of the counterbalancing shaft during tensioning, making the process of tensioning safer and more reliable.

The latching pin 410 may be spring-loaded to be biased against the corresponding groove of the shaft of the counterbalancing mechanism. Accordingly, the latching mechanism may comprise a spring mounted to said latching pin 410.

The latching pin 410 may extend along a latch axis LA. The latching mechanism 400 may further comprise a latch housing 411. The latching pin 410 may be movably arranged in said latch housing 411. The latching pin 410 may be connected to said latch housing 411 by means of the spring. The spring may be adapted to provide a biasing force onto the latching pin 410 extending along the latch axis LA. The biasing force may thus extend in a radial direction of the tool extending orthogonally to the axial direction of the shaft of the counterbalancing mechanism when the tool is mounted to the said shaft. Accordingly, the latching pin 410 may extend in a radial direction of the tool.

The latch housing 411 may be fix to the gear wheel 21. The latch housing 411 may be mounted to the gear wheel 21. In one embodiment, the latch housing 411 may be mounted to the fixating plate 337. In one embodiment, the latch housing 411 may be mounted to said fixating plate 337 by means of fastening elements such as screws.

As depicted in FIG. 10, the latching mechanism 400 may comprise an engagement flange 415 and a cam structure 405. The engagement flange 415 is fix to, e.g. fixedly mounted to, the latching pin 410. The engagement flange 415 extends orthogonally to the latching pin 410.

The engagement flange 415 is in engagement with the cam structure 405. The engagement flange 415 is further spring-loaded, by means of being fixed to the spring loaded latching pin 410, to be biased, i.e. resiliently biased, against said cam structure 405 such that rotation of the engagement flange 415 causes movement of the latching pin 410 between an engaged position and a disengaged position.

In the engaged position, the latching pin 410 is positioned to engage the corresponding groove of the shaft. In the disengaged position, the latching pin 410 is positioned to disengage the corresponding groove of the shaft of the counterbalancing mechanism.

With the above-referenced latching mechanism a user may control the engagement between the tool and the shaft of the counterbalancing mechanism by rotating the engagement flange which allows for safer tensioning. It further allows for a more user-friendly manner of fixating the tool to the shaft of the counterbalancing mechanism.

The latching pin 410 may thus be movable relative the latch axis LA between said engaged and disengaged position. The latching pin 410 may be spring-loaded to be biased towards the engaged position. The latching pin 410 is movable by means of rotation of the engagement flange 415 about the latch axis LA.

The cam structure 405 may be formed on an annular sleeve. The latching pin 410 may extend through said annular sleeve. The cam structure 410 may be formed as at least a part of an annular surface of said annular sleeve. The annular surface faces and is in contact and engagement with a corresponding surface of the engagement flange 415.

The annular sleeve may thus have a cam structure 405 in the form of at least a portion of an outer annular surface. The portion or the entirety of the outer annular surface may be diagonal relative the corresponding surface of the engagement flange 415 to enable movement of the latching pin 410 along the latch axis LA. In the depicted embodiment, the cam structure 405 is formed on a half of the outer annular surface of the annular sleeve.

As further depicted in FIG. 10, the cam structure 405 may include portions allowing for retention of the engagement flange 415. This enables securing of the latching pin in a safe position unless operation of said pin is required.

Accordingly, the cam structure 405 may comprise a disengagement retention groove 409 and/or an engagement retention groove 408. The disengagement retention groove 409 is adapted to receive and retain the engagement flange 415, i.e. a portion of the retention flange, in a position corresponding to the disengaged position of the latching pin 410. The engagement retention groove 408 is adapted to receive and retain the engagement flange 415, i.e. a portion of the retention flange, in a position corresponding to the engaged position of the latching pin 410.

The cam structure 405 may be formed as an at least partially annular and diagonal surface, whereby the engagement retention groove 408 is arranged at the sunken down portion of said surface and the disengagement retention groove is arranged at the elevated portion of said surface.

In operation, during fixation of the tool to the shaft, the latching pin 410 may be lifted out of engagement with the disengagement retention groove 409 by means of pulling of the engagement flange 415. Upon lifting of the latching pin 410, the engagement flange 415 is rotated against the cam structure 405 due the latching pin 410 being spring loaded as the latching pin 410 moves towards its engaged position. Upon the latching pin 410 reaching its engaged position, the engagement flange 415 is moved to and retained in the engagement retention groove 408. To disengage the latching pin 410, the engagement flange 415 may be lifted out of engagement with the engagement retention groove 407 by means of pulling of the engagement flange 415. The engagement flange 415 may then be rotated against the cam structure 405 causing movement of latching pin 410 towards its disengaged position. Upon the latching pin 410 reaching its disengaged position, the engagement flange 415 is moved to and retained in the disengagement retention groove 409.

According to an aspect, a torsion spring tensioning tool for tensioning a torsion spring of a counterbalancing mechanism of an overhead door is provided. The torsion spring tensioning tool 100 comprises a housing 80, a gear wheel arrangement 20 adapted to be mounted on a shaft of the counterbalancing mechanism. Said gear wheel arrangement 20 comprises a gear wheel 21 rotatably arranged in the housing 80. The torsion spring tensioning tool 100 further comprises a gear mechanism 54 coupled to the gear wheel 21 for rotating said gear wheel 21. The gear wheel arrangement 20 comprises a fixating arrangement 32, 320 fix to the gear wheel 21 and adapted engage the shaft of the counterbalancing mechanism and transmit a rotational movement from the gear wheel 21 to the torsion spring. Such a tool allows for a simple to use and robust torsion spring tensioning tool. As the skilled person recognizes such a tool may optionally include any one of the features and embodiments mentioned herein.

According to an aspect, a torsion spring tensioning tool according to any one of the below clauses is provided.

1. Torsion spring tensioning tool (100) for tensioning a torsion spring of a counterbalancing mechanism of an overhead door, wherein the torsion spring tensioning tool (100) comprises a housing (80), a gear wheel arrangement (20) adapted to be mounted on a shaft of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21),

wherein the gear wheel arrangement (20) comprises a fixating arrangement (32) fix to the gear wheel (21) and adapted to be fastened to the torsion spring of the counterbalancing mechanism and transmit a rotational movement from the gear wheel (21) to the torsion spring,

the torsion spring tensioning tool (100) further comprising a support gearing (50) in engagement with the gear wheel (21)) such that the gear wheel (21) is arranged between the support gearing (50) and the gearing mechanism (54).

2. The torsion spring tensioning tool (100) according to clause 1, wherein the support gearing (50) comprises a plurality of cogged wheels (51, 52, 53) each engaging the gear wheel (21).

3. The torsion spring tensioning tool (100) according to clause 2, wherein the plurality of cogged wheels (51, 52, 53) are distributed along the circumference of the gear wheel (21).

4. The torsion spring tensioning tool (100) according to any one of the preceding clauses, further comprising an adapter plate (30) releasably mounted to the housing (80), said adapter plate (30) being adapted to be mounted on the shaft of the counterbalancing mechanism.

5. The torsion spring tensioning tool (100) according to clause 4, wherein the adapter plate (30) comprises an aperture (38) for accommodating the shaft of the counterbalancing mechanism.

6. Torsion spring tensioning tool (100) according to any one of the preceding clauses, wherein the gear wheel (21) comprises a first wheel segment (24) and a second wheel segment (25), wherein the second wheel segment (25) is axially attachable to and axially detachable from the first wheel segment (24), wherein the first wheel segment (24) is adapted to be mounted on the shaft of the counterbalancing mechanism when the second wheel segment (25) is in a detached state.

7. The torsion spring tensioning tool (100) according to any one of the preceding clauses, wherein fixating arrangement (32) comprises a plurality of engagement members (41, 42, 43) adapted to engage corresponding engaging members of the shaft of the counterbalancing mechanism.

8. The torsion spring tensioning tool (100) according to clause 7, wherein the plurality of engagement members (41, 42, 43) comprises a threaded adjustable pin (43) and at least one retractable pin (41, 42).

9. The torsion spring tensioning tool (100) according to any one of the preceding clauses, wherein the housing (80) encloses the circumferential periphery of the gear wheel (21) and comprises a first housing part (81) and a second housing part (82) which are movable in relation to each other such that the gear wheel arrangement (20) is detachable from the housing (80).

10. The torsion spring tensioning tool (100) according to clause 9, wherein the first housing part (81) and the second housing part (82) are interconnected by means of a pivot connection (65).

11. The torsion spring tensioning tool (100) according to clause 9 or 10, wherein the first housing part (81) is lockable to the second housing part (82) by means of a locking arrangement.

12. The torsion spring tensioning tool (100) according to clause 11, wherein the locking arrangement comprises a locking element (83) movable between an engaged position and a disengaged position, wherein the locking element (83) in said engaged position locks the first housing part (81) relative the second housing part (82) and in said disengaged position releases the first housing part (81) relative the second housing part (82).

13. The torsion spring tensioning tool (100) according to any one of the preceding clauses, further comprising a lock lever (60) pivotally connected to the pivot connection (65), the lock lever (60) being pivotable between a first lock lever position and a second lock lever position, wherein the lock lever (60) is arranged to fixate the pivot connection (65) relative the second housing part (82) in the first lock lever position and accommodate relative movement between said second housing part (82) and pivot connection (67) in the second lock lever position.

14. The torsion spring tensioning tool (100) according to clause 13, wherein one of the second housing part (82) and the lock lever (60) comprises a tongue (88) and the other of the second housing part (82) and the lock lever (60) comprises a groove (69), wherein the tongue (88) and the groove (69) are arranged to engage and secure the second housing part (82) to the lock lever (60) when the lock lever (60) is in the first lock lever position.

15. The torsion spring tensioning tool (100) according to clause 13 or 14, wherein the lock lever (60) comprises a projection (62) arranged to come into contact with the housing (80) to provide a stop for the movement of the lock lever (60) upon reaching the first lock lever position.

16. The torsion spring tensioning tool (100) according to any one of clause 13 to 15, further comprising a securing member (64) adapted to engage the lock lever (60) in the first lock lever position to secure said lock lever (60).

17. The torsion spring tensioning tool (100) according to clause 16, wherein the securing member (64) is pivotable relative the housing (80) and the lock lever (60) comprises a securing portion (61), whereby the securing member (64) is pivotable between an engaged position in which the securing member (64) engages the securing portion (61) for securing the position of the lock lever (60) and a disengaged position wherein the lock lever (60) is freely pivotable between the first lock lever position and the second lock lever position.

18. The torsion spring tensioning tool (100) according to clause 16 or 17, wherein the securing member is connected to the housing (80) by means of a spring (97), said spring (97) resiliently biasing the securing member (64) towards the engaged position.

19. The torsion spring tensioning tool (100) according to any one of the preceding clauses, further comprising a handle lever (75) pivotally coupled to the housing (80) such that the handle lever (75) is pivotable relative the housing (80) between a first and second pivot end position in which the handle lever (75) engages the housing (80).

20. The torsion spring tensioning tool (100) according to clause 19, wherein the handle lever (75) comprises abutment elements (73, 74) arranged to engage the housing (80) in the first and second pivot end position.

21. The torsion spring tensioning tool (100) according to clause 19 or 20 when dependent on claim 15, wherein one of the abutment elements (73, 74) is arranged to press the projection (62) of the lock lever (60) against the housing (80) when the handle lever (75) is in the first pivot end position.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims

1. Torsion spring tensioning tool (100) for tensioning a torsion spring of a counterbalancing mechanism of an overhead door, wherein the torsion spring tensioning tool (100) comprises a housing (80), a gear wheel arrangement (20) adapted to be mounted on a shaft of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21), wherein the gear wheel arrangement (20) comprises a fixating arrangement (32, 320) fix to the gear wheel (21) and adapted to engage the shaft of the counterbalancing mechanism and transmit a rotational movement from the gear wheel (21) to the torsion spring, the torsion spring tensioning tool (100) further comprising a support gearing (50) in engagement with the gear wheel (21)) such that the gear wheel (21) is arranged between the support gearing (50) and the gearing mechanism (54).

2. The torsion spring tensioning tool (100) according to claim 1, wherein the support gearing (50) comprises a plurality of cogged wheels (51, 52, 53) each engaging the gear wheel (21).

3. The torsion spring tensioning tool (100) according to claim 2, wherein the plurality of cogged wheels (51, 52, 53) are distributed along the circumference of the gear wheel (21).

4. The torsion spring tensioning tool (100) according to claim 1, further comprising an adapter plate (30) releasably mounted to the housing (80), said adapter plate (30) being adapted to be mounted on the shaft of the counterbalancing mechanism.

5. The torsion spring tensioning tool (100) according to claim 4, wherein the adapter plate (30) comprises an aperture (38) for accommodating the shaft of the counterbalancing mechanism.

6. The torsion spring tensioning tool (100) according to claim 1, wherein fixating arrangement (32, 320) comprises a plurality of engagement members (41, 42, 43, 321, 410) adapted to engage corresponding engaging members of the shaft of the counterbalancing mechanism.

7. The torsion spring tensioning tool (100) according to claim 6, wherein the plurality of engagement members (41, 42, 43) comprises a threaded adjustable pin (43) and at least one retractable pin (41, 42).

8. The torsion spring tensioning tool (100) according to claim 6, wherein the plurality of engagement members (321) of the fixating arrangement (320) forms at least one cogged surface adapted to engage corresponding splines of the shaft of the counterbalancing mechanism.

9. The torsion spring tensioning tool (100) according to claim 8, wherein the at least one cogged surface forms at least a partial ring gear rim.

10. The torsion spring tensioning tool (100) according to claim 8, wherein the plurality of engagement members (321) forms the at least one cogged surface on any one or each of the gear wheel (21) and a fixating plate (337) attached to the gear wheel (21).

11. The torsion spring tensioning tool (100) according to claim 10, wherein the gear wheel (21) is formed as a ring wheel and the plurality of engagement members (321) forms at least a part of an internal ring gear rim of said ring wheel.

12. The torsion spring tensioning tool (100) according to claim 10, wherein the at least one cogged surface forms a gear rim of the fixating plate (337).

13. The torsion spring tensioning tool (100) according to claim 12, wherein the gear rim of the fixating plate (337) is inwardly facing.

14. The torsion spring tensioning tool (100) according to claim 8, wherein the fixating arrangement (320) further comprises a latching mechanism (400) with a latching pin (410) adapted to engage a corresponding groove of the shaft of the counterbalancing mechanism.

15. The torsion spring tensioning tool (100) according to claim 14, wherein the latching pin (410) is spring-loaded to be biased against the corresponding groove of the shaft of the counterbalancing mechanism.

16. The torsion spring tensioning tool (100) according to claim 15, further comprising an engagement flange (415) and a cam structure (405), the engagement flange (415) being fix to the latching pin (410) and extending orthogonally to said latching pin (410), the engagement flange (415) being in engagement with the cam structure (405) and spring-loaded to be biased against said cam structure (405) such that rotation of the engagement flange (415) causes movement of the latching pin (410) between an engaged position and a disengaged position of said latching pin (410) in which the latching pin (410) is positioned to engage and disengage the corresponding groove of the shaft of the counterbalancing mechanism, respectively.

17. The torsion spring tensioning tool (100) according to claim 16, wherein the cam structure (405) comprises a disengagement retention groove (409) adapted to receive and retain the engagement flange (415) in a position corresponding to the disengaged position of the latching pin (410).

18. The torsion spring tensioning tool (100) according to claim 16, wherein the cam structure (405) comprises an engagement retention groove (408) adapted to receive and retain the engagement flange (415) in a position corresponding to the engaged position of the latching pin (410).

19. Torsion spring tensioning tool (100) according to claim 1, wherein the gear wheel (21) comprises a first wheel segment (24) and a second wheel segment (25), wherein the second wheel segment (25) is axially attachable to and axially detachable from the first wheel segment (24), wherein the first wheel segment (24) is adapted to be mounted on the shaft of the counterbalancing mechanism when the second wheel segment (25) is in a detached state.

20. The torsion spring tensioning tool (100) according to claim 1, wherein the housing (80) encloses a circumferential periphery of the gear wheel (21) and comprises a first housing part (81) and a second housing part (82) which are movable in relation to each other such that the gear wheel arrangement (20) is detachable from the housing (80).

21. The torsion spring tensioning tool (100) according to claim 20, wherein the first housing part (81) and the second housing part (82) are interconnected by means of a pivot connection (65).

22. The torsion spring tensioning tool (100) according to claim 20, wherein the first housing part (81) is lockable to the second housing part (82) by means of a locking arrangement.

23. The torsion spring tensioning tool (100) according to claim 22, wherein the locking arrangement comprises a locking element (83) movable between an engaged position and a disengaged position, wherein the locking element (83) in said engaged position locks the first housing part (81) relative the second housing part (82) and in said disengaged position releases the first housing part (81) relative the second housing part (82).

24. The torsion spring tensioning tool (100) according to claim 21, further comprising a lock lever (60) pivotally connected to the pivot connection (65), the lock lever (60) being pivotable between a first lock lever position and a second lock lever position, wherein the lock lever (60) is arranged to fixate the pivot connection (65) relative the second housing part (82) in the first lock lever position and accommodate relative movement between said second housing part (82) and pivot connection (67) in the second lock lever position.

25. The torsion spring tensioning tool (100) according to claim 24, wherein one of the second housing part (82) and the lock lever (60) comprises a tongue (88) and the other of the second housing part (82) and the lock lever (60) comprises a groove (69), wherein the tongue (88) and the groove (69) are arranged to engage and secure the second housing part (82) to the lock lever (60) when the lock lever (60) is in the first lock lever position.

26. The torsion spring tensioning tool (100) according to claim 24, wherein the lock lever (60) comprises a projection (62) arranged to come into contact with the housing (80) to provide a stop for the movement of the lock lever (60) upon reaching the first lock lever position.

27. The torsion spring tensioning tool (100) according to claim 24, further comprising a securing member (64) adapted to engage the lock lever (60) in the first lock lever position to secure said lock lever (60).

28. The torsion spring tensioning tool (100) according to claim 27, wherein the securing member (64) is pivotable relative the housing (80) and the lock lever (60) comprises a securing portion (61), whereby the securing member (64) is pivotable between an engaged position in which the securing member (64) engages the securing portion (61) for securing the position of the lock lever (60) and a disengaged position wherein the lock lever (60) is freely pivotable between the first lock lever position and the second lock lever position.

29. The torsion spring tensioning tool (100) according to claim 27, wherein the securing member is connected to the housing (80) by means of a spring (97), said spring (97) resiliently biasing the securing member (64) towards the engaged position.

30. The torsion spring tensioning tool (100) according to claim 1, further comprising a handle lever (75) pivotally coupled to the housing (80) such that the handle lever (75) is pivotable relative the housing (80) between a first and second pivot end position in which the handle lever (75) engages the housing (80).

31. The torsion spring tensioning tool (100) according to claim 30, wherein the handle lever (75) comprises abutment elements (73, 74) arranged to engage the housing (80) in the first and second pivot end position.

32. The torsion spring tensioning tool (100) according to claim 31, wherein one of the abutment elements (73, 74) is arranged to press the projection (62) of the lock lever (60) against the housing (80) when the handle lever (75) is in the first pivot end position.
